(19) United States
(12) Patent Application Publication
(10) Pub. No.: US 2015/0020006 A1
(43) Pub. Date: Jan. 15, 2015

(54) METHOD AND SYSTEM FOR CREATING DYNAMIC BROWSER-BASED USER INTERFACE BY EXAMPLE

(71) Applicant: PASSCALL ADVANCED TECHNOLOGIES (TRANSFORMA) LTD., Haifa (IL)

(72) Inventor: Zeev Kotzer, Haifa (IL)

(73) Assignee: PASSCALL ADVANCED TECHNOLOGIES (TRANSFORMA) LTD., Haifa (IL)

(21) Appl. No.: 14/381,178

(22) PCT Filed: Feb. 26, 2013
(86) PCT No.: PCT/IL2013/050179

§ 371 Date: Aug. 26, 2014

Related U.S. Application Data
(60) Provisional application No. 61/603,293, filed on Feb. 26, 2012.

(51) Int. Cl. G06F 3/0484

(52) U.S. Cl. CPC G06F 3/0484
USPC 715/762

(57) ABSTRACT

A system for creating, editing, maintaining and using interactive UI on a plurality of different types of mobile devices. The system allows intuitive, fast and virtually error-free development of interactive UI by semi-automatically creating and integrating codes based on examples designed by a UI designer. The system provides menu-driven development of the sample code and menu-driven tools for integrating the sample code such that editing and modifying the sample code is minimized. The system is capable of creating applications to be loaded on the end-users' mobile device that enable using the UI, and allows browsing the UI from end-users' mobile device.

### FIELD OF THE INVENTION

The present invention relates to a system and method for generating browser-based dynamic user interface used for providing communication between a server and plurality of mobile devices of different hardware types such as mobile phones, Smartphones, and tablets running browsers.

### BACKGROUND OF THE INVENTION

Building dynamic browser-based User Interfaces (UI) requires time-consuming work on design and implementation of integration between sources of data and the UI.

Specifically, the information must be accessible by a plurality of users having devices of different types. Generally, each device type may have a display characterized by various parameters such as: dimensions, resolution, browser software type and version etc. It should be mentioned that particular devices may require generation of particular browser codes (like HTML, CSS, Javascript, etc.) due to difference in browsers/versions, and device capabilities.

Typically, mobile devices such a Smartphone use displays that are smaller than commonly used in stationary computers (such as a PC), tablets or laptop computers. The UIs have to be adapted to be comfortably viewed on the small displays of mobile devices. Additionally, different device types may have different input devices such as controls, touch screen, multi-touch screen, etc. UIs have to be adapted to be comfortably operated on the small displays and with the different input devices used in mobile devices. Additionally, different devices (even of same device types) may have different Operating Systems (OS), or different browsers or different versions of them. Thus, creating a communication system that responds to user's commands, and displays dynamic information on a plurality of types of devices and/or a plurality of OS's and browsers requires adaptation of the display format. As the data to be displayed is updated, the system is required to adapt the updated data to each of the supported devices, OSs and browser types.

Usually, as known in the art, the following steps are taken during the creation of the application UI for a specific user's device:
1) UI design—the designer designs the UI that would be used on the users' device.
2) Data interface definition—defining the content, structure and semantics of the data to be provided to the UI, for example, definition of a set of JSONs, XMLs or web services
3) Data interface implementation—writing the code to implement step 2) above.
4) UI development according to the design—writing the code to implement the design from step 1) above.
5) UI & Data integration—integrating the data as defined in step 2) above into the data interface of step 3) above.

In many cases steps 3) and 4) are done in parallel to save time, both relying on the data interface definition from step 2).

It is quite common that the initial definition of the data interface (from step 2) above) changes during the development. The UI design usually requires some changes and adjustments after using the first versions of the UI on real life target devices/browsers with real data.

Therefore, it is very common that the integration step encounters problems, takes longer than expected, is found hard to stabilize, and/or needs to be repeated more than once due to the required changes after real life tests.

The more people and organizations are involved in the process, the more fragile, complex and time-consuming the whole process becomes. As a result, the process may be costly and revenues may be lost or delayed.

Some background information on the subject may be found in some of the following patents and applications:
1. US2010262902: Schema Based User Interface Mechanisms
2. WO2005010645(A2): Application User Interface Template With Free-From Layout
3. US2008d40679: System And Method For Xml Based Data Driven Generation Of A Composite Source User Interface
4. US2008120557: Dynamic Generated Web UI For Configuration
5. US2010241978: Dynamic Generation Of User Interfaces And Automated Mapping Of Input Data For Service-Oriented Architecture-Based System Management Applications
6. US2010251133: Method And System For Providing A User Interface In A Computer
7. US20d7011650: Computer Method And Apparatus For Developing Web Pages And Applications
8. U.S. Pat. No. 8,046,736: Generated Code From Graphical User Interface
9. US20d5193361: System And Method For Presentation Of Wireless Application Data Using Repetitive UI Layouts
10. G82470838: Inserting Generic Code Into A Website To Enable A Website Optimisation System.

### SUMMARY OF THE INVENTION

Building dynamic browser-based User Interfaces (UI) and adapting pages to be used on mobile devices requires time-consuming work on design and implementation of integration between the sources of data and the UI. The embodiments of the current invention provide a system and methods that greatly reduce the efforts needed for accomplishing these tasks.

Using the invention saves work hours, reduces the time to complete the tasks, and reduces debugging and correcting times.

Additionally, the invention allows for using personnel of lower skills as the stage of integration is done by following examples and is partially automated.

Some of the possible benefits of using the invention may be:
Some embodiments provide a fast and easy complete solution for building mobile web applications. Using the invention requires little or no knowledge of mobile technology since the creation of the mobile code is done automatically by the system.
Some embodiments enable immediately testing the created specifications on an emulator or real devices, even before performing any coding, integration or development.
Some embodiments allow the designer to demonstrate a few states on the same screen (for example guest and logged-in user) and switch states when building and reviewing the UI.
Some embodiments enable the designer to leave notes for the integrator, thus saving time and improving results,
Some embodiments allow demonstrating more than one state of a single page or element, such way that all the possible states of the UI are accurately specified and can be all easily implemented and verified later,
Some embodiments enable using predefined templates, sites, skins and palettes, and then customizing them.
Some embodiments define automatically the client-server protocol, generate the client side and a working skeleton server side code, leaving the integrator only with plugging in the business logic.
Some embodiments enable easy adaptation to a large collection of supported mobile devices such as Smartphones, Tablets; feature phones; Personal Digital Assistant (PDA), personal media players with communication capabilities, and the likes.
Some embodiments enable easy and automatic generation of web applications.
Some embodiments allow deployment with one click to multiple clouds of choice, such as production or testing environments
Some embodiments allow deployment of a same application both as a mobile web application to a variety of devices (from feature phones to tablets), and as a standalone downloadable application.
Some embodiments provide details pane with high-level viewpoint and quick control or UX attributes
Some embodiments provide automatic real-time data integration, in the server and/or in the client application.
Some embodiments provide real-time per-device ML and images generation (such as HTML5, XHTML, cHTML, WML, JPEG, GIF, PNG etc)
Some embodiments provide Multi-level caching [data, images, XML, HTML]
Some embodiments provide generation of Quick Response codes for quick preview of the UI and/or access and download for the end users
Some embodiments automatically generate code (such as JavaScript and/or HTML) to be integrated in web sites for detecting access from mobile devices and redirecting them to the corresponding mobile location.

It is an aspect of the current invention to provide a method for creating a dynamic User Interface (UI) to be used on a plurality of mobile devices of different types, the method comprising: using a graphical Integrated Design Environment for designing at least one page template, wherein designing said Page template comprises: inserting at least one object in said at least one Page template; designing the appearance of said Page template; and defining behavior of said Page template according to predefined states; using a graphical Integrated Design Environment for designating a name to said at least one object in said at least one of the Page template; and automatically generating a sample code, wherein said sample code includes a code section comprising the name of said at least one object, and sample data indicative of the said at least one object as appears in said Page template; integrating a modified code by replacing in the sample code, the sample data with actual dynamic data capable of causing the code to send the corresponding data from the relevant record in a dynamically updated database.

In some embodiments the designing said Page template further comprises associating said Page with at least one predefined state; and said automatically generating a sample code further comprises automatically generating code capable of controlling the behavior of said Page depending on actual value of said state during browsing said Page.

In some embodiments the method further comprises storing code capable of executing said method on a computer-readable media.

In some embodiments the method further comprises executing said method on a computer.

In some embodiments the method further comprising automatically generating Pages, configured to be browsed by a supported small-screen mobile device by executing said modified code.

In some embodiments the supported small-screen mobile device is capable of browsing said Page via Internet.

In some embodiments the method further comprises automatically generating an application, configured to be executed on a supported small-screen mobile device by executing said modified code.

In some embodiments the method further comprises dynamically updating said dynamically updated database.

In some embodiments the dynamically updated database is a computer drive.

It is another aspect of the current invention to provide a system for creating a dynamic User Interface (UI) to be used on a plurality of mobile devices of different types, the system comprising: a computer system, capable of enabling a UI designer to: use a graphical Integrated Design Environment for designing at least one Page template, wherein designing said Page template comprises: inserting at least one object in said at least one Page template; designing the appearance of said Page template; and defining behavior of said Page template according to predefined states; said computer system is further capable of enabling an integrator to: use a graphical Integrated Design Environment for giving a name to said at least one object in said at least one of the Page template; automatically generating a sample code, wherein said sample code includes a code section comprising the name of said at least one object, and sample data indicative of the said at least one object as appears in said Page template; and integrating a modified code by replacing in the sample code, the sample data with actual dynamic data capable of causing the code to send the corresponding data from the relevant record in a dynamically updated database.

In some embodiments the system further comprises: a plurality of supported devices; a back-end server; and at least one data source, wherein said back-end server is capable of executing said modified code, and capable of interacting with said plurality of supported devices, wherein said interaction of said back-end server with said plurality of supported devices comprises providing data from said data source to plurality of supported devices.

In some embodiments the plurality of supported devices are selected from a group consisting of: Smartphones, Tablets; feature phones; Personal Digital Assistant (PDA), and personal media players with communication capabilities.

In some embodiments the interaction of said back-end server with said plurality of supported devices comprises communication over the Internet.

In some embodiments the interaction of said communication over the

Internet comprises browsing web-pages generated by said back-end server on at least one of said plurality of said supported devices.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 schematically depicts a system and the method that enables preparing and presenting information according to an exemplary embodiment of the current invention

FIG. 2 schematically shows the design environment used by the UI specialist for Per-device page generation according to the method seen in FIG. 1 according to an exemplary embodiment of the current invention.

FIG. 3 schematically shows the system used for WebApp (real-time) Production Environment in accordance with an exemplary embodiment of the current invention.

FIG. 4 schematically depicts a system used as an offline application production environment in accordance with an exemplary embodiment of the current invention.

FIG. 5 schematically depicts an example of a physical system that enables preparing and presenting information according to an exemplary embodiment of the current invention.

FIG. 6 schematically depicts an example of system that enables preparing and presenting information according to yet another exemplary embodiment of the current invention.

FIG. 7A schematically depicts an example of a view of a log-in page created by a UI designer by interacting with IDE 620 according to exemplary embodiment of the current invention.

FIG. 7B schematically depicts an example of a view of a page used by a UI designer for adding a heading to canvas in accordance with an exemplary embodiment of the current invention.

FIG. 8A schematically depicts the parts of the system used by UI designer to review the designed UI using emulation and simulation tools in accordance with an exemplary embodiment of the current invention.

FIG. 8B schematically depicts the emulation tool used by UI designer to review and test designed UI using emulation and simulation tools in accordance with an exemplary embodiment of the current invention.

FIG. 9A schematically depicts the parts of the system used by Data Integrator 640 to integrate the designed UI in accordance with an exemplary embodiment of the current invention.

FIG. 9B schematically depicts an integration tool used by Data Integrator to further develop the UI code in accordance with an exemplary embodiment of the current invention.

FIG. 10 schematically depicts the modifications performed by Data Integrator to the sample UI code in order to configure it to real data pertaining to other products that may be obtained by the end user in accordance with an exemplary embodiment of the current invention.

FIG. 11 schematically depicts the parts of the system during the operation (runtime) of the system in accordance with another exemplary embodiment of the current invention.

### DESCRIPTION OF THE DRAWINGS AND EXEMPLARY EMBODIMENTS OF THE INVENTION

The present invention relates to a system and method for providing communication between a server and plurality of communication user-interfacing devices of different types such as mobile phones, Smartphones, and tablets running a browser.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The terms “comprises”, “comprising”, “includes”, “including”, and “having” together with their conjugates mean “including but not limited to”.

The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements were omitted from some of the drawings. Some optional elements are marked by dashed lines.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

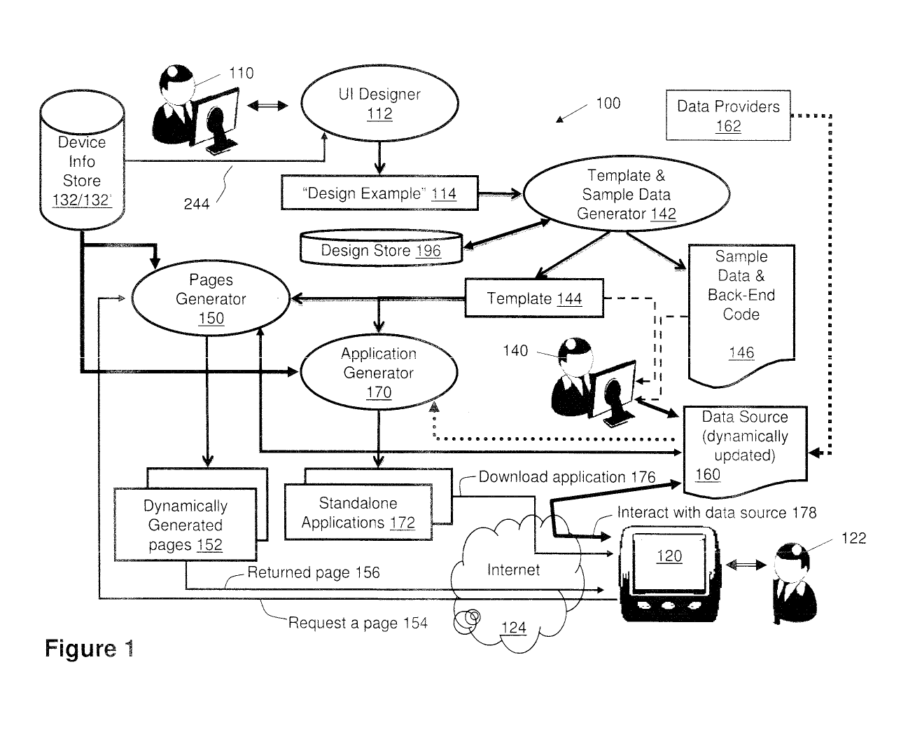

FIG. 1 schematically depicts a system 100 and the method that enables preparing and presenting information according to the exemplary embodiment of the current invention.

It should be noted that the challenge of building dynamic browser-based User Interfaces (UI) for mobile devices is due to the need to adapt the code to the specific hardware of the specific type of supported mobile device. Specifically, the physical screen size of each type of mobile device is generally different. Additionally, the resolution (number of pixels), aspect ratio, and color representation or pallet may be different. Additionally, the user's input hardware and operation used in mobile devices may be different. For example touch screen may be used instead of mouse as used in Personal Computers (PC). Alternatively, touch-pads or joystick may be used. Additionally, the code that displays and operates the UI has to be loaded onto the non-volatile hardware memory of the mobile device and be executed on the processor of the mobile device.

FIG. 1 schematically depicts the essential physical components of system 100: The communication channels between these components as well as the logical block diagram and the operation of system 100. Another common difficulty in developing mobile UI is related to the need to develop code in two environments—client (device) and server (back-end) and implement a stable protocol between the parts for passing the information back and forth. These parts of the development are time consuming and require a variety of programming skills

### 1. A UI Designer Tool

A UI specialist 110 interacts with software termed “UI designer” 112 to prepare exemplary pages that he wants to display to the end user 122 on supported devices 120.

The UI specialist 110 may create more than one page, or more than one page type (for example: pages providing information about products, pages allowing an end user to become a registered customer, pages allowing an end user to purchase the products, and so on.). The UI specialist 110 may customize the exemplary pages to one or preferably a plurality of types of supported device 120 such as: Smartphones, tablets, PCs, Laptops, (of various types), etc.

The UI specialist 110 may optionally use information about the different types of supported devices 120 stored in a “device info store” 132, for example to find information about screen size, resolution and the likes. The device info store 132 may contain information about each type of supported device such as: display size and resolution, color representations, font types, and other information as detailed in the background section.

The UI specialist 110 uses actual information, or fabricated information with the UI designer tool 112. Using actual information or realistic fabricated information allows the UI specialist 110 to view a simulated realistic version of the UI he/she is designing and judge its appearance. For example, when UI specialist 110 is designing a UI to be used for purchasing items from a specific vendor, he may use actual information provided by the actual vendor such as product names, product descriptions, prices, and product images. Alternatively, UI specialist 110 may use fabricated information of similar characteristics such “generic” products names, fabricated text as product descriptions, generic images, etc. Preferably UI specialist 110 chooses the fabricated information such that it at least resembles the actual information to be eventually used in term of length of text and image resolution, colors and details.

The UI design tool 112 allows characterizing the UI by using an example or a plurality of examples of the expected outcome. The UI designer 112 is typically a combination of UI design tools and UI builders as can be found in many development environments. Implementation and integration guidelines are specified by the UI specialist 110 within the designer 112, as properties of the UI when possible, and as free text otherwise. Optionally, the UI specialist 110 may insert comments, requirements, suggestions and/or instructions to be used later, for example by members of the development team such as data integrator or a graphical designer 140.

The UI specialist 110 may use some of the UI designer 112 to create a sample UI, and then test the sample UI with the target runtime environment (or a plurality of runtime environments) during the design phase. The runtime environments may be the specific devices, or device types that the system supports. Actual or simulated runtime environments may be used.

The output of the UI designer tool 112 is information in the form of “Design Examples” 114 which could be in the form of a “web page” or “Sample UI”.

The UI specialist 110 typically creates at least one, and usually a plurality of Design Examples 114.

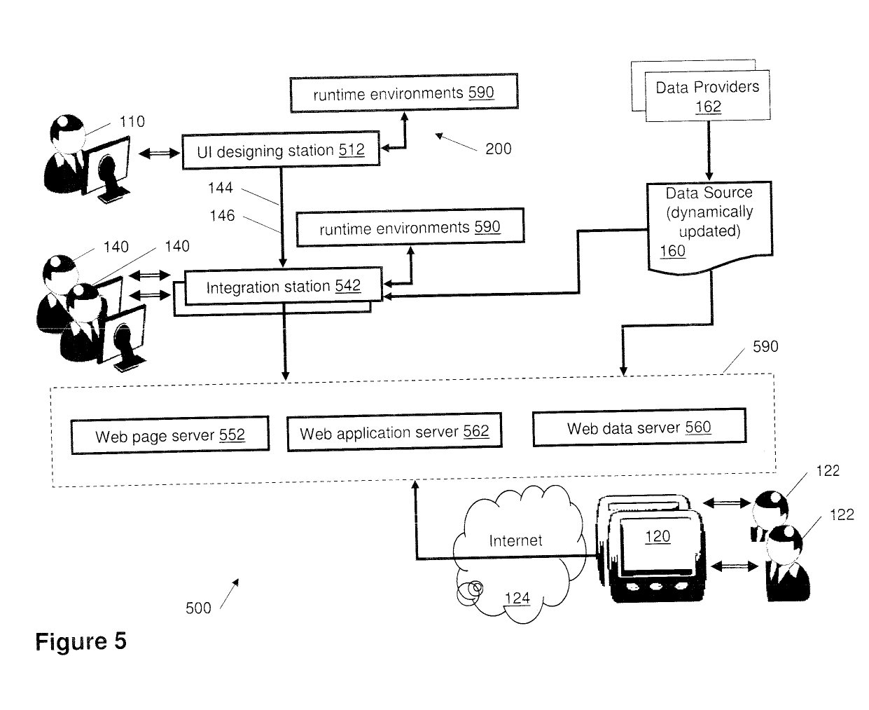

Optionally and preferably, designer tool 112 is implemented on a UI designing computing system 512 (shown in FIG. 5) such as a PC, server or a workstation used by UI specialist 110. Optionally UI designing computing system 512 is connected to at least one, and preferably a collection 590 of supported devices or supported device emulators for runtime environments testing.

2. A template, Sample Data and Back-End Code Generator

The Design Example(s) 114, generated by the UI designer tool 112, as instructed by the UI specialist 110 is used by a “template, sample data and back-end code Generator” software tool 142.

The template, sample data and back-end code generator 142 analyzes each of the design examples 114, and generates for each design example a “Template” 144 and “Sample Data” 146. Template 144 and the corresponding sample data 146 are configured in such a way that feeding this sample data 146 into the corresponding template 144 using the “Pages Generator” 150 will produce the given design example 114.

Similarly, other data (for example, data stored in the dynamically updated data source 160), having the same structure as the sample data 146, can also be used by the pages generator 150 to generate valid pages (such as the dynamically generated pages 152) with the corresponding other data.

The Sample Back-End code is generated based on the Sample Data, by generating a readable and compact code that constructs the Sample Data and sends/receives it from or to the server. The sample back-end code is generated in one of plural programming languages such as Java, C#, Python or php according to the Data Integrator preference.

For example, if the template 144 requires that the first datum is the product name, and it is to be displayed at the center of the page, and the second datum is its price and it is to be displayed at the bottom of the page, then the sample data 146 will have a text entry first (for example “Toothbrush”, and a second entry a price number (for example “$1.50”).

For another example, if a page is showing a list of 5 products, with a picture, a name and a price for every product, the generated template 114 will contain the structure of one exemplary product display, and the sample data will list the picture, name and price of the products in the sample

Templates 144 are stored in a “design Store” 196, to be used when needed.

### 3. Data Source

Data source 160 is an information storage that stores the actual data that is to be displayed on the supported devices 120, to be viewed and used by the end users 122.

The “Data Integrator” 140 observes the template(s) 144 and the structures of the corresponding sample data 146 and ensures that the “Data source” 160 conforms to the required structure.

It should be noted that the workload of the data integrator 140 (or a plurality of data integrators 140) is greatly reduced by the examples (template(s) 144 and sample data 146) which are automatically provided to him by the template and sample data generator 142. The automatic generation of matching template 144 and sample data 146 saves time and prevents errors.

Data source 160 is information storage, a collection of data storage devices, or interface to outside data that is dynamically generated or updated, for example by “Data Providers” 162.

“Data Providers” 162 may be a data gathering software that collects data from outside sources such as internet servers. For example, in a page that displays weather forecasts at different cities, data provider 162 may be the weather sections in Internet websites of local news stations. Data providers may be automatic software agents, for example search engines, or other agents that computes the updated, added, or deleted data in the data source. The end users 122 may also cause changes to the data source, for example by entering his details, by making a transaction, by entering a request, by posting data, and the likes.

### 4. Interaction With the “End User” 122 Via His “Supported Device” 120.

The “End User” 122 uses his “supported Device” 120, to view and interact via the Internet 124 with web pages and interactive UIs designed by the UI specialist 110 and generated by the system 100 with the currently-updated data in the data source 160. The supported device 120 is a mobile device, generally having a small display such as less than 10 inches. For example, tablet computers may have 7-10.1 inches displays; Smartphones may have 3-5 inches displays; and Feature Phones may have 2.5-4 inches displays. Supported device 120 may interact with corded, but preferably wireless communication channels such as cellular, Wi-Fi or other technologies and protocols which were not marked for clarity of the figures. Generally, end user 122 interactively uses his supported device 120 to view, search and perform operations such as purchasing products and services from vendors using system 100.

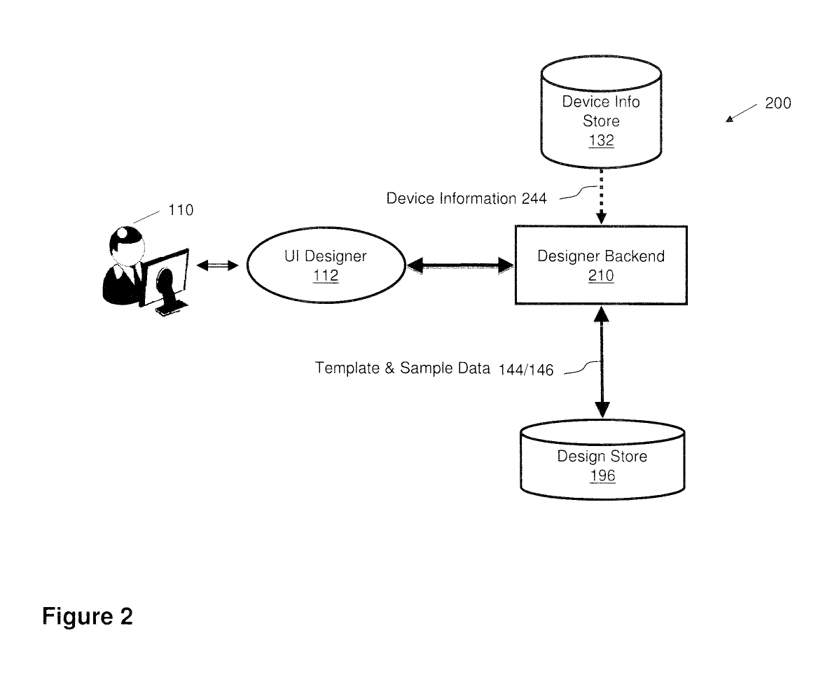

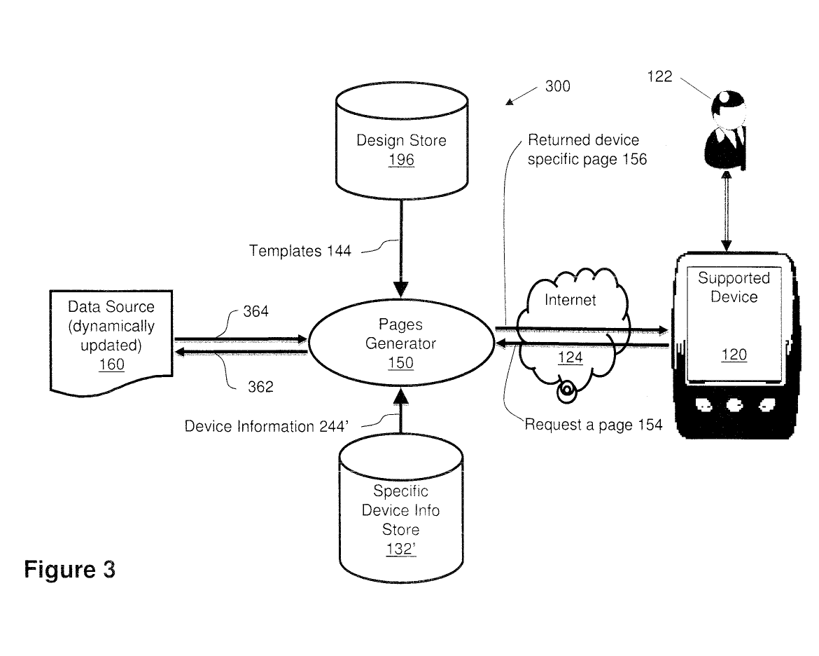

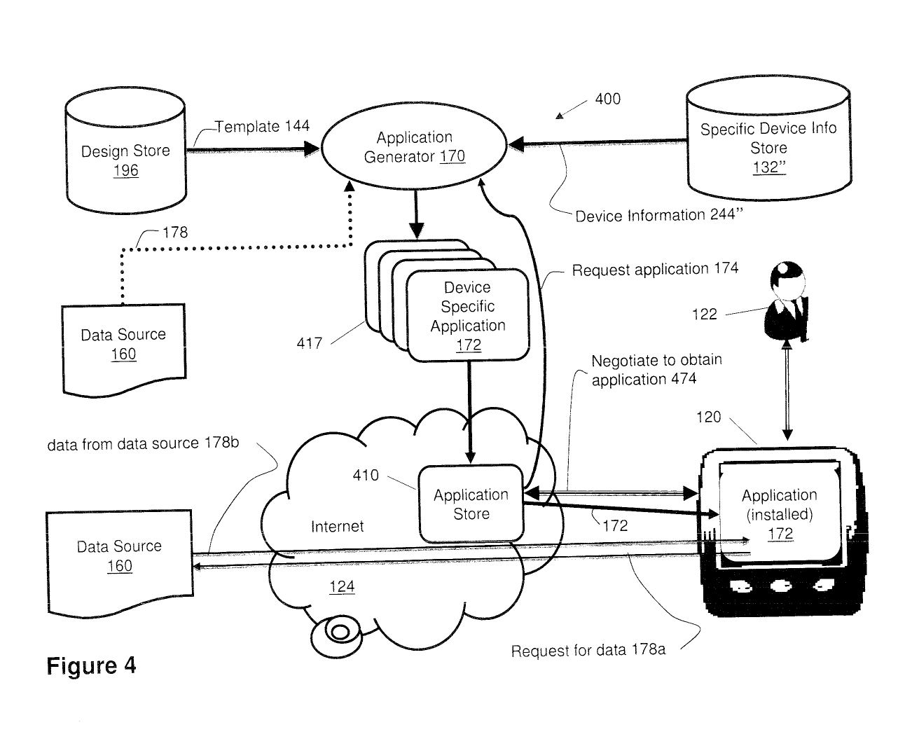

It should be noted that optionally, while the UI designer 110 may use, and be aware of only a small number of pre-defined supported device types (like “feature-phone”, “smart-phone”, “tablet”, “TV”, and the likes) and not bounded to any one, few, or all the device types, it is the page generator 150 and the application generator 170 that may perform a more detailed adaptation to the specific supported device 120. Thus, the “device info store” 132 (seen in FIGS. 1 and FIG. 2), which is used by the UI specialist 110, may not be identical, and may be less detailed than the “specific device info store” 132′ seen in FIG. 3 or the “specific device info store” 132″ seen in FIG. 4, which may optionally not be identical to each other.

The supported device 120 may use one or both of the following ways of obtaining pages to be displayed to end user 122:
Obtaining “Dynamically Generated Pages” 152, generated by pages Generator 150
Or
Using “Standalone Application” 172, generated by “Application Generator” 170 and downloaded onto the Supported Device 120.

### 4.1 Obtaining Dynamically Generated Pages 152, Generated by Pages Generator 150

In the first method of obtaining pages, the end user 122 uses his supported device 120 to send a request 154 to view or request to interact with a page to the page generator 150. This embodiment is seen in FIG. 3 which schematically depicts a system and method used by supported device 120 for obtaining dynamically generated pages 152 generated by page generator 150 according to exemplary embodiment of the current invention.
a) The supported device 120 sends via the Internet 124 a request 154 to a server, together with information about the type of the supported device 120.
b) The request is received by the Page Generator 150 in the server which:
   1. Selects from the design store 196 the template 144 appropriate to the type of the supported device (and the requested page, if a plurality of page types is available).
   2. Inserts into the selected template 144 the appropriate data from the data source 160, and
   3. Generates (renders) the requested page 152.
c) The generated page 152 is sent 156 to the supported device 120 via the Internet 124 and is viewed (or interacted) by the end user 122.

The process repeats every time the end user 122 desires to view or interact with another page.

Optionally, the requested page 152 may already exist and be stored on the web page server 552 (seen in FIG. 5). In this case, the web page server may not need to generate it again (unless the data source 160 had been updated and the page needs updating). For this purpose, the server may comprise a cache of generated pages 152 (not seen in this figure for drawing clarity). Pages in the cache of generated pages may optionally be generated only when requested by a supported device 120 and stored for additional later use. Alternatively or additionally, pages in the cache of generated pages may optionally be generated off-line and stored for use when requested.

Optionally, in order to use a cached page, the requested page needs to have the same data and same type of supported device.

Optionally the system caches separately in multiple levels:
The data (downloaded XML/JSON for instance).
The data after merged into UI elements.
The device-specific page after being adapted to a device.

The supported device 120 may optionally send specific information to be used by the server to perform other actions, for example to update the data source 160, or to update other databases, for example to perform transactions such as purchasing a product, etc.

### 4.2 Using “Standalone Application” 172, Generated by “Application Generator” 170 and Downloaded Onto the Supported Device 120.

In the second method, the end user 122 interacts directly with the data source 160, using an application 172 created for his type of supported device. This embodiment is shown in FIG. 4 which schematically depicts a system and method used by supported device 120 for obtaining dynamically updated pages by using stand alone application 172 executed on supported device 120 according to another exemplary embodiment of the current invention.
a) In the second method, the end user 122 first downloads 176 via the internet 124 a “Standalone Application” 172, that was automatically generated by the “Application Generator” software 170, onto his supported device 120. The application 172 may be generated as a result of request 174 (seen in FIG. 4) from the application store 410, or the application is selected from a list of applications already prepared by the application generator 170 and stored to be used when requested. The application generator 170 may use 178 some information in the data source 160 for customizing or updating the generated application 172.
b) When the end user 122 desires to view or interact with a specific page, he activates the application 172 (already downloaded and installed on his supported device 120). The supported device 120, using the application 172, interacts 178 with the data source 160. For example, the application 172 may request a specific data from the data source 160, obtain the requested information, and display the data to the end user 122 on the display of the supported device.
   Additionally or alternatively, the application may send data to the data source.
c) The application generates the requested page(s), on the supported device, using the data obtained from the data source.
   For example, application 172 may be an application enabling the user 122 to view weather forecast is a specific city. In this case, activation of application 172 displays a UI page allowing the end user to type or select the desired city and optionally the time or date of the desired forecast. Application 172 interacts 178 with data store 160 to obtain the needed data regarding the desired forecast, and uses the obtained information to generate and display a page showing the desired forecast on the display of the supported device 120.
d) For example, application 172 may be an application enabling the user 122 to purchase merchandise (real, or virtual such as data of music). In this case, activation of application 172 displays a UI page allowing the end user to type or select the desired merchandise and the terms and/or means of payment (such as credit card number). Application 172 interacts 178 with data store 160 to update the data store 160 with the purchase request and information. Data store 160 uses the information for commencing the transaction, and may return to the application 172 transaction confirmation information. Application 172 may use the obtained confirmation information to generate and display a page showing the transaction confirmation information on the display of the supported device 120. Steps b) and c) are repeated each time the user desires to view or interact with a page, (unless the application has all the needed information to render the page and then only step d is repeated).

Optionally, the supported device may be loaded with a plurality of applications 172, each directed at different types of pages or actions.

Optionally, the requested page application 172 may already exist and stored on the web page server 552 (seen in FIG. 5). In this case, the web page server may not need to generate it again (unless the data source 160 had been updated and the page needs updating). For this purpose, the server may comprise a cache of generated pages 152 (not seen in this figure for drawing clarity). Pages in the cache of generated pages may optionally be generated only when requested by a supported device 120 and stored for additional later use. Alternatively or additionally, pages in the cache of generated pages may optionally be generated off-line and stored for use when requested.

FIG. 2 schematically shows the design environment 200 used by the UI specialist for Per-device page generation according to the method seen in FIG. 1 according to an exemplary embodiment of the current invention.

The design environment 200 used by the UI specialist for Per-device page generation is also seen in FIG. 5. The design environment 200 may be implemented on a single computer or workstation, or it may be a collection of computers, servers hard disks, etc. Optionally, design environment 200 may comprise runtime environment 590 (seen in FIG. 5) for viewing, testing, editing and reviewing the created pages. Runtime environment 590 may comprise an actual collection of supported devices, and a communication system enabling to communicate with them. Additionally or alternatively, runtime environment 590 may be implemented as device emulators executed on the UI designing station 512 (seen in FIG. 5), or on a separate computer or computers.

The UI specialist 110 uses a computer system or a terminal, for example UI designing station 512, for executing his parts of the method of FIG. 1. Designer UI 112 interfaces with a server or other system infrastructure (Designer Backend 210) which stores the created templates 114 and sample data 146 in a data storage (Design Store 196). The designer 112 may optionally use device information 244 about the different types of supported devices 120 stored in a “device info store” 132. The device info store 132 may contain information about each type of supported device such as: display size and resolution, color representations, font types, and other information.

The workload on the UI specialist 110 is greatly reduced since he is exempt from performing the data integration which is performed by data integrator(s) 140. Consequently, UI specialist 110 may have more time to develop the functionality, the usability, artistic creativity and appearance of the UI and pages.

When a plurality of data integrators 140 are used (as seen in FIG. 5), errors, confusion and inconsistencies are eliminated, or greatly reduced by the fact that all the data integrators 140 are using the same templates 144 and sample data 146 created by the same UI specialist 110.

FIG. 3 schematically shows the system used for WebApp (real-time) Production Environment 300, as explained in section 4.1 “Obtaining Dynamically Generated Pages” 156, generated by Pages Generator 150 above in accordance with an exemplary embodiment of the current invention.

FIG. 3 shows the page generator application 150, generally located on a server (for example the web page server 552 seen in FIG. 5), interacting with the supported device 120 via the internet 124. It should be noted that the term “Internet” is to be generalized to a communication channel in general. For example, a large company may use Intranet instead of Internet, or other forms such as LAN, WAN, Cellular, Wi-Fi, \ or other wired or wireless communication, not necessarily using Internet protocols.

Supported device 120 submits a request for a page 154 to the Pages Generator 150. Request 154 includes information 362 about the requested page. Request 154 further includes, or is associated with the type of supported device 120 that sent the request.

The page generator 150 may require three types of information in order to respond the request of the supported device:
Information about the design of the page—this information may be obtained from the “design store”, for example in the form of template 144.
Information 244′ about the specific requirement of the supported device 120—this information 244′ may be obtained from the device info store 132′. Information 244′ may optionally be different, optionally more detailed than the information 233 (seen in FIGS. 1 and 2) used by the UI specialist 110 and the UI designer 112.
Information 362 comprises indication as to what page-specific information 364 should be inserted into the page template 144—this page information 364 may be obtained from the data source 160.
   In response to the request for a page 154, the Pages Generator 150 returns to the supported device 120 a specific page 156, containing the desired page specific information 364, formatted for the specific type of the supported device 120. Supported device 120 then presents the returned page 156 to the end user 122.

FIG. 4 schematically depicts a system 400 used as offline application production environment and used in the method explained in section 4.2 above, using Standalone Application 172, automatically generated by Application Generator 170, which is downloaded, installed and executed by the Supported Device 120.

FIG. 4 shows the application generator application 170, generally located on a server (for example the web application server 562 of FIG. 5), interacting with the supported device 120 via the internet 124. It should be noted that the term “Internet” is to be generalized to a communication channel in general. For example, a large company may uses Intranet instead of Internet, or other forms such as LAN, WAN, or wireless communication not necessarily using Internet protocols.

The method of displaying pages on the supported device using stand alone application comprises two stages: A) Installing the stand alone application on the supported device, and B) using the installed application to display the pages.

A) Installing the Stand Alone Application on the Supported Device.

The supported device 120 negotiates 474 with a server such as application store 410 (seen in FIG. 4) or web application server 562 (seen in FIG. 5) to obtain a copy of application 172. The negotiation 742 may comprise purchasing the application 172, or application 172 may be free or obtained in return to registration or other action that does not include payment.

To obtain a copy of application 172, end user 122 submits a request for the application to the server, requesting an application. The request may be submitted to the application store 410 directly from the supported device 120, or using other means such as phone, or another computer. The request for application may comprise the following information:
Information about the specific type of the supported device 120—This information is contained in the request sent (for example by the supported device). The information may comprise information regarding both the hardware type of the supported device 120 and its software environment such as type and version of OS or other applications already installed on the supported device. Optionally, the request comprises ID code that identifies the supported device, while the information or parts of the information is stored at the server.
Information about the specific application requested—This information is contained in the request 174 sent by the supported device, and it points to the page or pages or UI that the requested application 172 should display on the supported device 120.
Information regarding payment or other authorization to obtain the Application—This optional information may not be needed when the application is free. The information may be obtained from comparing the ID of the supported device to a list of authorized devices, or it may be sent to other components in the server.

The application store 140 may be different (financially, or organizationally, or physically) from the unit that prepares the application, as depicted in FIG. 4. Alternatively, application store 410 may be missing or integrated into the web application server 562 as seen in figure 5. Once the negotiation to obtain the application is successful, application generator 170 receives a request 174 (directly, or from application store 410). The application generator 170 may require two types of information in order to respond to the request 174 of the supported device 120 and generate the requested Device Specific Application 172, tailored to the specific type of the supported device 120:
Information about the design of the page—this information may be obtained from the design store 196.
Information about the specific requirement of the supported device—this information may be obtained from the specific device info store 132″.
   The operating comprises the following steps:
a) The end user 122 causes the supported device 120 to send (directly or via application store 410) a request 174 to the application generator 170 to obtain a standalone application tailored for his supported device.
b) The application generator 170 generates the needed application 172.
c) Alternatively, if such application has already been prepared and stored, the application generator 170 directs the supported device 120 to an application storage device (for example a hard drive) 417 that stores the required application code.
   Optionally, and preferably, application generator 170 generates and stores application for some or all types of supported devices. The web application server 562 then supplies the appropriate application when one is requested.
   Optionally, the generated applications are stored on an “application Store” server 410. Application store 410 may be remote from the server where application generator 170 is executed, and may even belong to a different commercial or organizational entity. The end user 122 may download, or purchase and download the needed application(s) from the Application Store 410 as known in the art.
d) The supported device 120 downloads and installs the application 172.

B) Using the Installed Application to Display the Pages.

In order to use the UI or to view a page or pages, the end user 122 activates the installed application 172 to perform a method comprising:
a) The end user 122 activates the installed application 172 and request to view or interact with a page.
b) The application 172 sends a request 178a (FIG. 4) for information needed to render the requested page to the data store 160 via the Internet 124. The request may be submitted directly to data store 160, or may be mediated by web data server 560 (FIG. 5).
c) The data store 160 replies with the needed information 178b via the internet 124.
d) The application 172 renders the desired page locally at the supported device 120 and displays it locally to the end user 122.
e) Steps a-d may repeat every time the user desires to view or interact with the same or another page supported by the application 172. It should be noted that several applications 172 may be installed, or even executed on the same supported device 120.

Optionally, the data 178b is modified and at least partially tailored to the requirements of application 172 by web data server 560. For example, data source 160 may serve a plurality of different types of supported devices and/or a plurality of different versions of applications 172, or be used for supporting both methods: “Obtaining Dynamically Generated Pages” and “using stand alone application”. In these cases, the data format may need adaptation.

FIG. 5 schematically depicts an example of a physical system 500 that enables preparing and presenting information according to an exemplary embodiment of the current invention.

FIG. 5 depicts a UI specialist 110 interacting with the design environment 200.

In the depicted example, design environment 200 comprises a UI designing station 512 and a runtime environment 590.

The resulting templates 144 and sample data 146 are used by a plurality of data integrators 140 at their Integration stations 542. In the depicted example a runtime environment 590 is used by data integrators 140 for testing, reviewing and quality assuring the resulting pages and UIs.

Data providers 162 continuously update the data in data source 160.

A plurality of end users 122, each having at least one supported device 120, view pages and/or uses UIs on their supported devices 120 via Internet 124. The interaction is done with one or few of: web page server 552, web application server 562 and/or web data server 560, collectively denoted as web server 590.

Optionally, a code for executing the invention is loaded on a data storage device such as a computer hard drive, or a read only disk such as a CD or DVD. The code is then executed on a processor, such as a PC computer or other computing hardware, and used by the UI integrator 140.

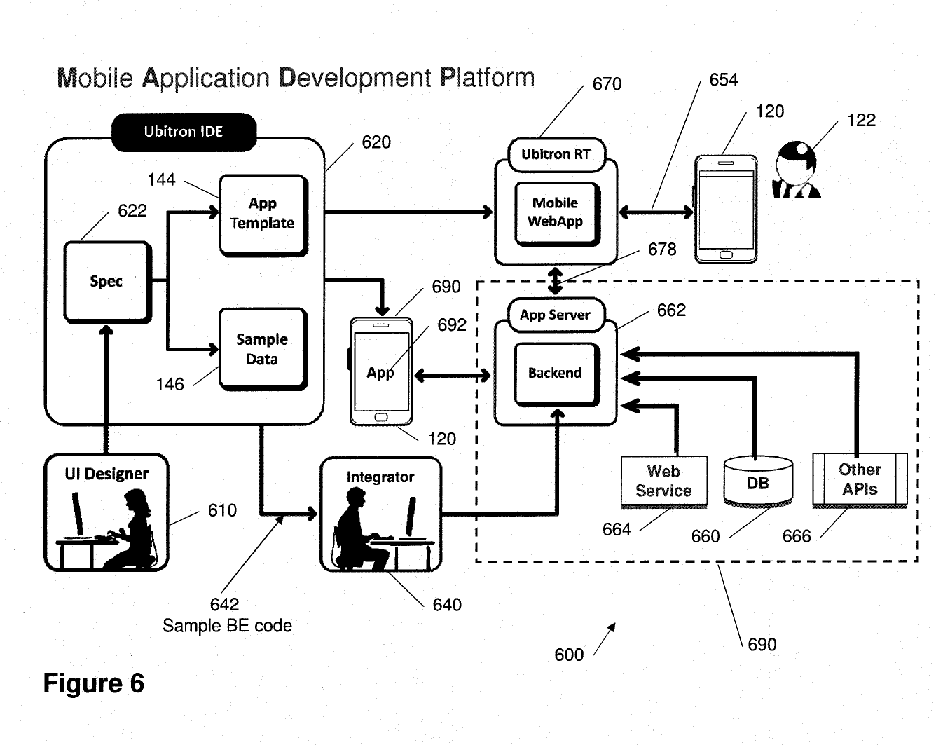

FIG. 6 schematically depicts an example of system 600 that enables preparing and presenting information, according to yet another exemplary embodiment of the current invention.

At the first, stage of the process, the design stage, Ubitron

Integrated Design Environment (IDE) 620 creates UI specification 622. In methods of the art, UI specifications are created using graphical design tools, and contain only the visual appearance of the UI. Team members then have to translate these specifications to executable codes. In contrast, UI designer 610 interacts with IDE 620 via a “canvas” interface to create UI specification 622, which allows associating logical and operational properties to the components that are placed on the UI canvas. The UI designer 610 may preview mockup (simulation) of the designed UI on screen. Optionally, the UI designer 610 may preview mockup of the designed UI on a supported device 690.

At the second stage of the process, the integration stage, the integrator integrate the Back End code (BE code) in a semi-automatic way. At this stage the integrator gives names to UI elements, adds real data and tests the UI with real data.

At the third stage of the process, the publication stage, codes (which, for example were generated in XML or JSONs) are deployed to the internet cloud and are available to the end users. Alternatively, application 692 may be loaded.

At the last stage, the runtime stage, end users download the codes and use the UI on their supported device. The end user 122 may use his supported device 120 to interact (for example browse 654, using a browser installed in his device 120) with the Mobile web application server—Ubitron Run-Time (RT) 670. In this case, RT 670 fetches data 678 from (and possibly updates data to) the backend Web Application server (App Server) 662. In this mode of operation, the supported device is browsing web pages using a browser. Alternatively, application 692 executed in the device 690 may exchange data 694 with App Server 662. Information in App Server 662 may be updated by at least one information source such as Web Service (for example a search engine or software agent) 664, Data Base (DB) 660; and/or other Application Program Interfaces (API) 666. These are but few examples to possible data sources which may be called by the back-end to store to retrieve data.

The following figures provide some more details about the methods used in the current inventions.

UI design stage:

It should be noted that UI designer 610 (110 in FIGS. 1, 2, and 5) creates on the canvas a specific example of the page, as she/he would like to see it displayed on the supported device 120 during runtime. To do so, UI designer 610 uses an exemplary representative data. For example, when designing a page that offers to purchase a product, UI designer 610 may use data as: a name, images, price, availability, and the likes of a representative product that is in the actual inventory. For example, when designing a login page, UI designer 610 may data such as: his name, his email address, his password and the likes.

The sample back-end code and the sample data that are automatically created at the end of the UI design process are capable of reproducing the designed example on a supported device. This occurs when the sample back-end code is executed and fetches information indicated in the sample data.

Integration Stage:

During the integration stage, the sample code is modified by integrator 640 (140 in FIGS. 1 and 5) to create a modified back-end code. The modification of the sample code enables the modified code to fetch during its run-time execution data stored in dynamically updated data source. This modification transforms the sample back-end code that displays a specific example to a modified code that is capable of presenting to the end user a plurality of similarly fashioned pages, each with relevant current data element replacing the corresponding sample data elements.

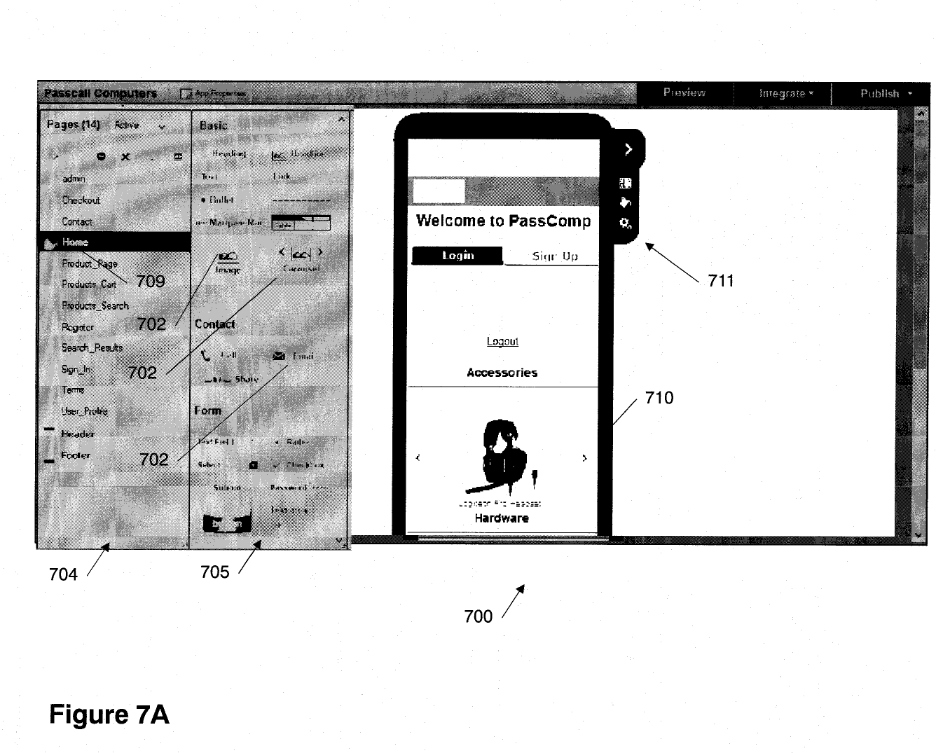

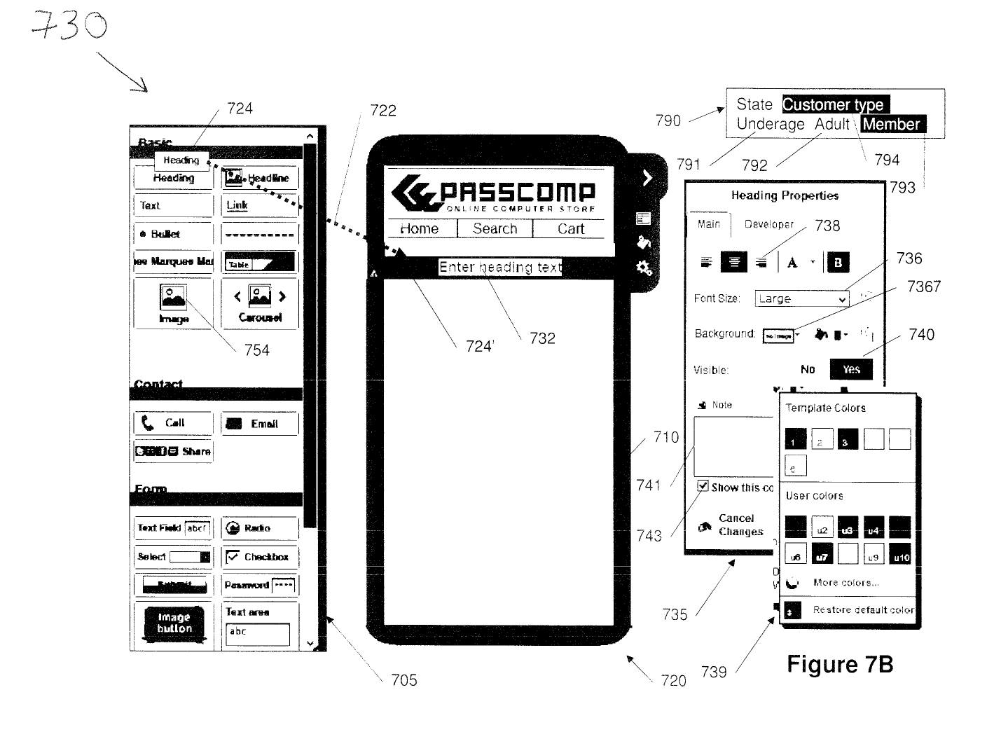

FIG. 7A schematically depicts an example of a view of an application main page 700 created by a UI designer 610 by interacting with IDE 620 according to exemplary embodiment of the current invention.

The UI designer 610 uses the “What You See Is What You Get” (WYSIWYG) interface to drag and features 702 (only few are marked for drawing clarity) from menu pages 704 and text area pages 705 onto “canvas” 710 that represents the small format display of a supported device.

The UI page in this exemplary case is a main page that will be used by an end user to start the process of purchasing computer hardware, from the website of an exemplary vendor “PassComp”. Exemplary pages may be stored in a database, and be selected from the menu 704. In this case “home page” 709 is selected in the pages menu 704, meaning that the UI Designer is currently changing this page.

Generally, the UI comprises a plurality of pages. The pages are designed and their logical relationships are defined using the menus available in the IDE 620.

Canvas 710 has its menu and option tab 711 controlling the properties and appearance of canvas 710.

FIG. 7B schematically depicts an example of a view of a page 730 that may be used for specifying “heading text”, text formats, other heading properties and notes to a “heading object” 732 on canvas 710.

After UI designer has dragged 722 the “heading” object 724 from the “basic” menu 705 onto canvas 710, and positioned the heading object (now indicated as 724′) on the canvas 710, she (or he) may enter heading text 732 to be displayed. UI designer may format the heading object box 724′ and the heading text 732 by applying formatting chosen from the “Heading Properties” menu 735 with its sub-menus such as “font size” 736, background 737, justification 738 and other formatting options.

In this figure, a sub-menu “color template” 739 appears once the user chooses to color, for example the background or the text in heading 724′.

In contrast to graphical software packages such as Microsoft PowerPoint wherein objects entered by the user are visual objects only, The UI designer can specify properties to the objects that influence the way the object behaves when displayed as part of the UI presented to the end user 122 on the supported device 120, when the end user is using the UI. For example, visibility 740 may be selected, notes 741 may be entered, and the option 743 to show the comment 741 in the XML code may be selected.

In addition, IDE 620 may enable the UI designer to define and associate a “state” to the UI page she is designing on canvas 710 by using the state menu 790. The state associated with a UI page controls the behavior of the UI page. For example, the designer selected to associate the UI page with a “member” (793) “customer type” (794). This association automatically indicates that the designed UI page will be displayed only to registered members of the PassComp buying group, and not to guests and unregistered users. For example, the UI page displayed to “members” may offer reduced prices, may include fields such as windows where the member can enter a gift-coupon number (if he has one) to get further discounts, etc. Optionally, multiple states may be associated with a UI page, such as both “Member” (793) and “underage” (791). Unlike “Adult” (792) state that may display all the merchandise and services, an underage customer (member or not) may not be able to access some of the merchandise or services such as tobacco, alcohol or gambling. Associating a UI page with a state (or a plurality of states) may create a code that causes the UI page to be displayed in this state, or may associate a specific database from which information is presented in fields in the UI page when the state is active (for example reduced vs. full prices for members and non-member states accordingly).

UI flow may also be controlled by states. For example, when the “stock availability” is in state “in stock”, and the user clicks the “I want it” button, the code created may direct the user to a “checkout” UI page; while when the “stock availability” is in state “out of stock” and the user clicks the “I want it” button, the code created may direct the user to a UI page offering him to accept delay in delivery or choose an alternative product.

It should be noted that the optional feature of defining states may save considerable time when coding the UI, saves debugging and simplifies the creating and integrating the UI.

In similar manner, the UI designer may position images, tables, links, buttons and other objects on canvas 710. For example, the UI designer may drag the “image” object 754 from the “basic” menu 705 onto canvas 710.

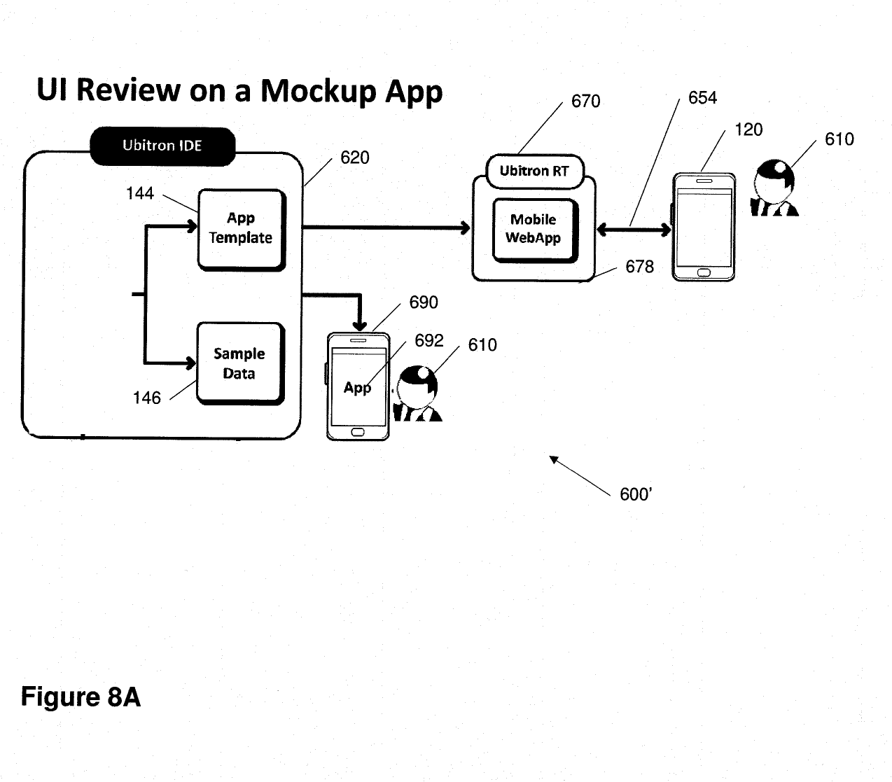

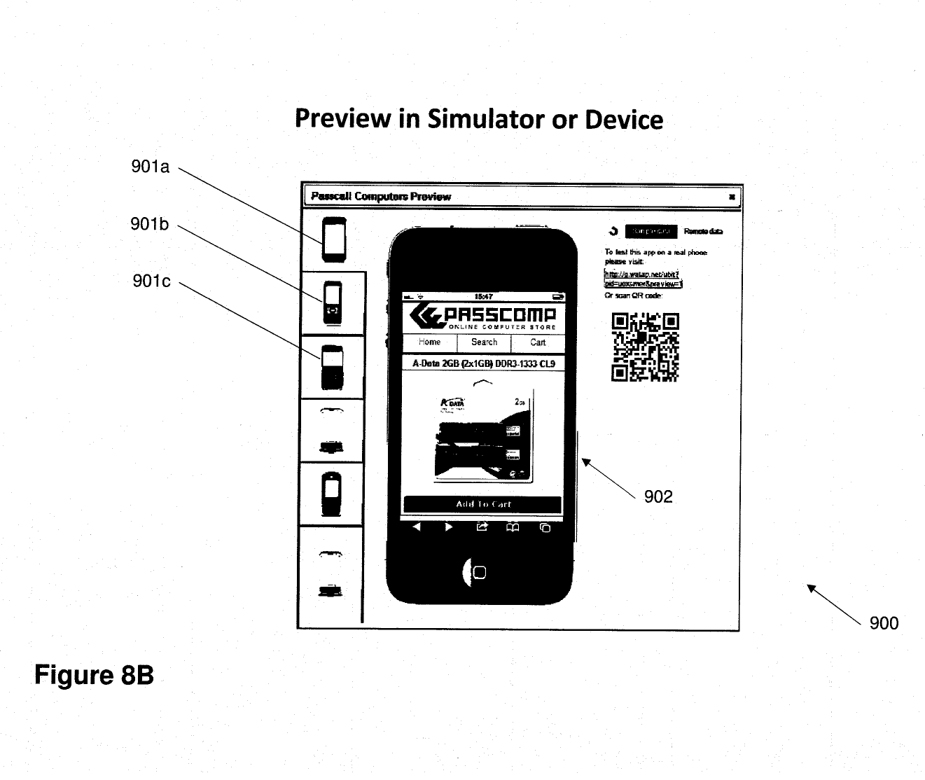

FIG. 8A schematically depicts the parts 600′ of system 600 (seen in FIG. 6), used by the UI designer to review the designed UI using emulation and simulation tools available in the system 600 (FIG. 6).

A simulation of the operation of the design UI may be performed, used and tested on an actual supported device 120 using the Mobile web application server—Ubitron Run-Time (RT) 670. Alternatively or additionally, emulation be performed, used and tested.

FIG. 8B schematically depicts the emulation tool 900 used by UI designer 610 to review and test designed UI using emulation and simulation tools available in system 600.

In the depicted embodiment, the emulation tool 900 displays 902 the designed UI page as it would be seen on the selected 901a type of supported device (for example an Apple™ iPhone®). Other supported types of devices, such as 901b, 901c, may be selected.

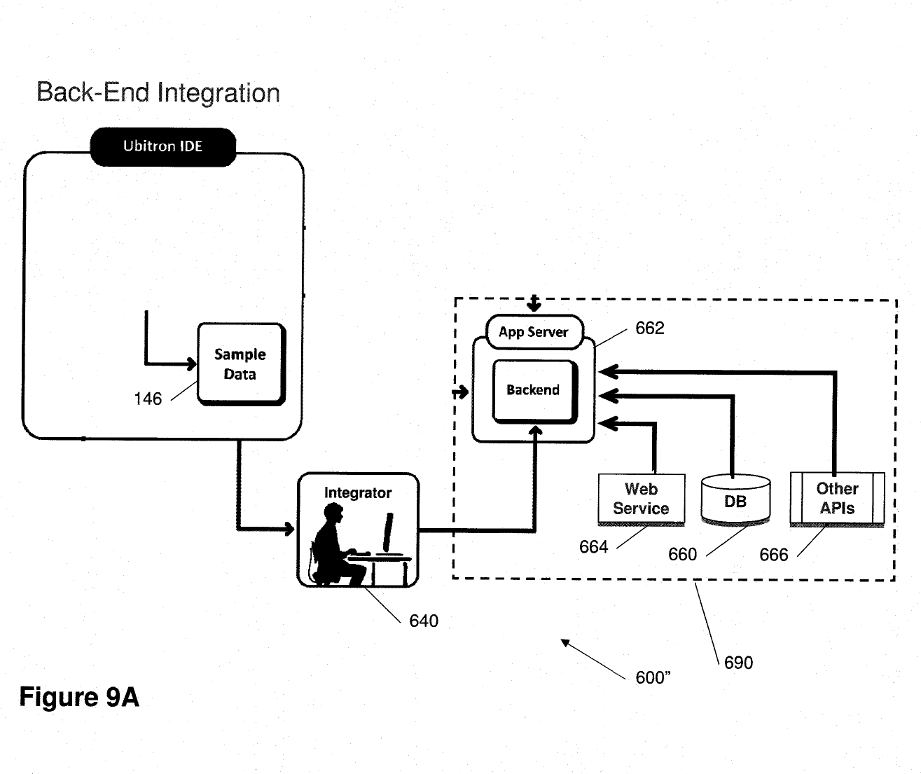

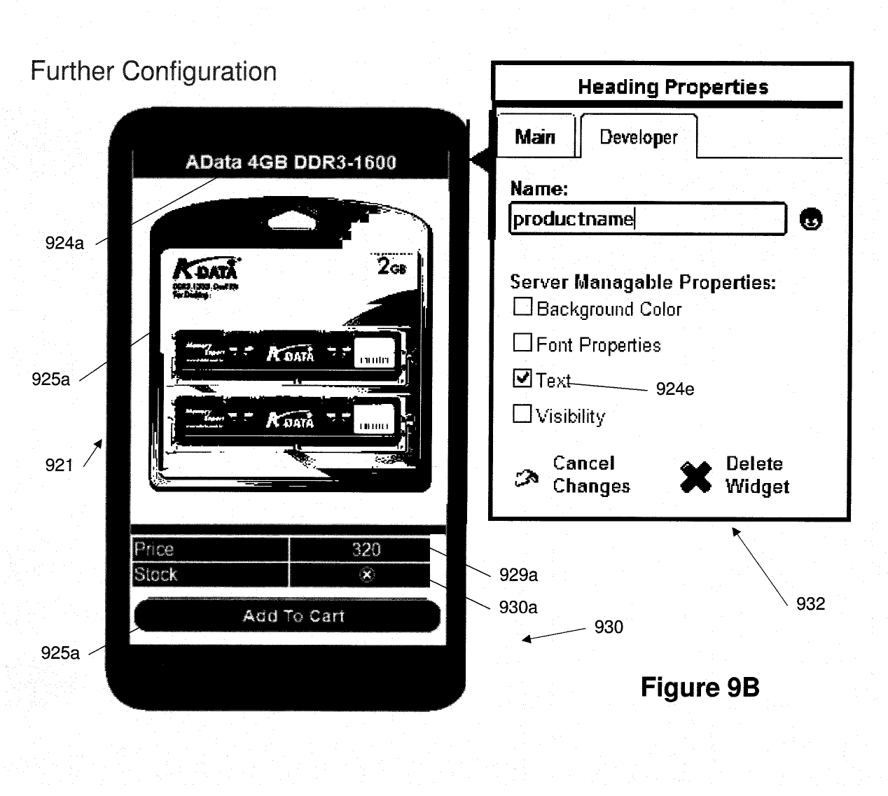

FIG. 9A schematically depicts the parts 600″ of system 600 (seen in FIG. 6), used by Integrator 640 to integrate the designed UI using tools available in system 600.

Integration is performed using the backend Web Application server (App Server) 662 on the designed sample data 146 designed by the by UI designer 610.

FIG. 9B schematically depicts an integration tool 930 used to further develop the UI code.

On the left of the screen (921), the Data Integrator 640 can see the UI page as will be seen by the end user. In the example seen, the text 924 indicates that the desired UI is aimed at offering to the end user to purchase 4GB of computer memory in the form of two 2GB memory cards type DDR3 which have a product identification DDR3-1600.

Furthermore, a selected element can be configured, in this case the “product name” 924a, by associating it with a code variable “productname” 924b, and by identifying it as “text” 924e from menu 932.

Other objects such as the image of the product 925a may similarly be treated.

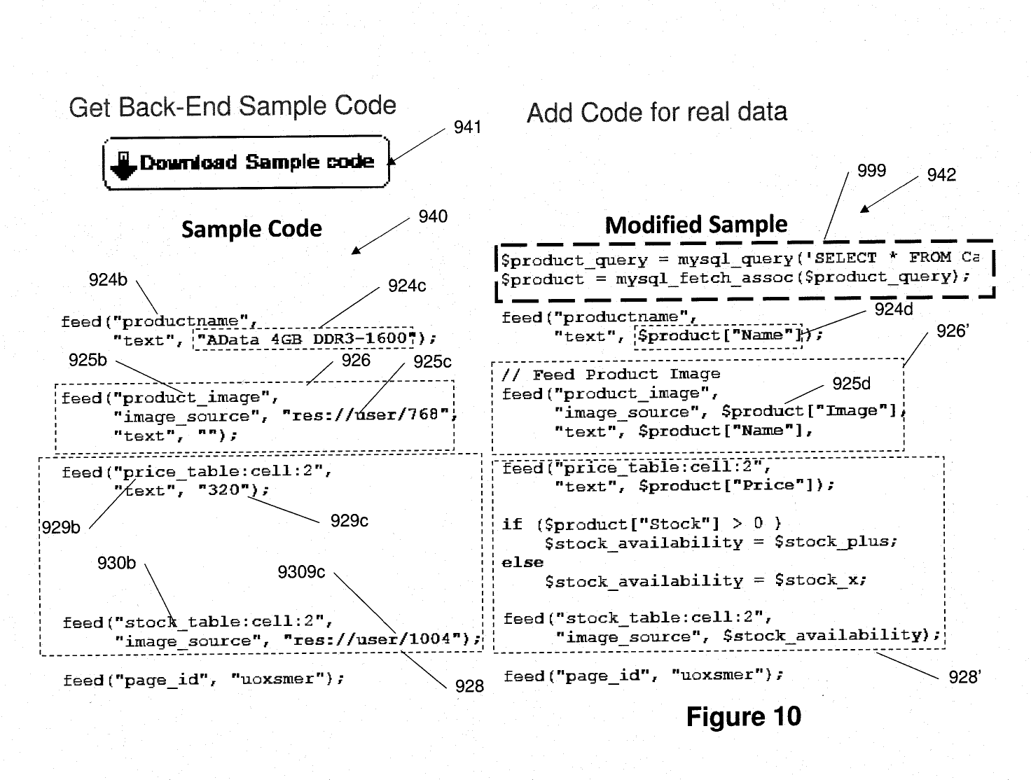

FIG. 10 schematically depicts possible modifications performed to the sample back-end code in order to provide data pertaining to the actual product being displayed to the end user on a Supported Device.

The sample code 940 is automatically generated by IDE 620 based on the designated Page examples 902. The code includes the object names associated with the objects, for example: “productname” 924b, which is associated with the sample text “AData 4GB DDR3-1600” 924c, both related to the product name 924a, as seen in the example 921 of FIG. 9B (or 902 of FIG. 8B which is generally the same as designed on canvas 710).

Similarly, the sample code includes section 926, pertaining to the image 925a (FIG. 9B), and including the object name (“product_image” 925b), its identifier (“image_source”) and the source of the sample image 925a (“res://user/768” 925c) is automatically created.

Similarly, the sample code includes section 928, pertaining to the price 929a and availability 930a which including the object name (“price_table:cell:2” 929b) its identifier “text” and the sample data (“320” 929c); and the object name (“stock_table:cell:2” 930b) its identifier “image_source” and the sample data (“res://user/1004” 930c).

The sample back-end code 940 is downloaded to the editing tool by pressing a “download sample code” button 941.

The identifiers such as “productname”: 924a, and the sample text associated with it “Data 4GB DDR3-1600” 924c can be easily identified by integrator 640.

To modify the sample back-end code 940 into 942, at least the following is performed:
Specifying the Relevant Data Source

The data source is inserted into a section 999, that identifies the relevant data source for the actual data during runtime.
Replacing the Exemplary Sample Data With Pointers to the Dynamically Updated Data:

The exemplary data is replaced with corresponding actual dynamic data to point to locations in the data base 660 where dynamically updated data is stored.

For example, the integrator 640 replaces the exemplary product name “Data 4GB DDR3-1600” 924c with a place-holder (or index) “$product[“name”] 924d in the modified code 942, causing the code to send the product name, in this example taken from the field “name” in the product database record.

Similarly, the section 926 in sample code 940 that defines the image of the product (925a in FIG. 9B), is modified to 926′ to replace the specific image “res://user/768” 925c with the actual product “$product[“Image”] 925d taken from the Image database field, as well as the product “$product[“name”] showing again as the image text.

Other elements of the code such as price and availability section 928 pertaining to price (929a of FIG. 9B) and stock availability (930a of FIG. 9B) are similarly modified in the code to the corresponding 928′

Alternatively, Data Integrator 640 can work directly with the Sample Data instead of the sample code, by specifying a ‘Pure Data’ programming language, get sample XML or JSON instead of code that generates the data, and create the dynamic data in the same format demonstrated by the Sample Data with any software or system capable of generating the data.

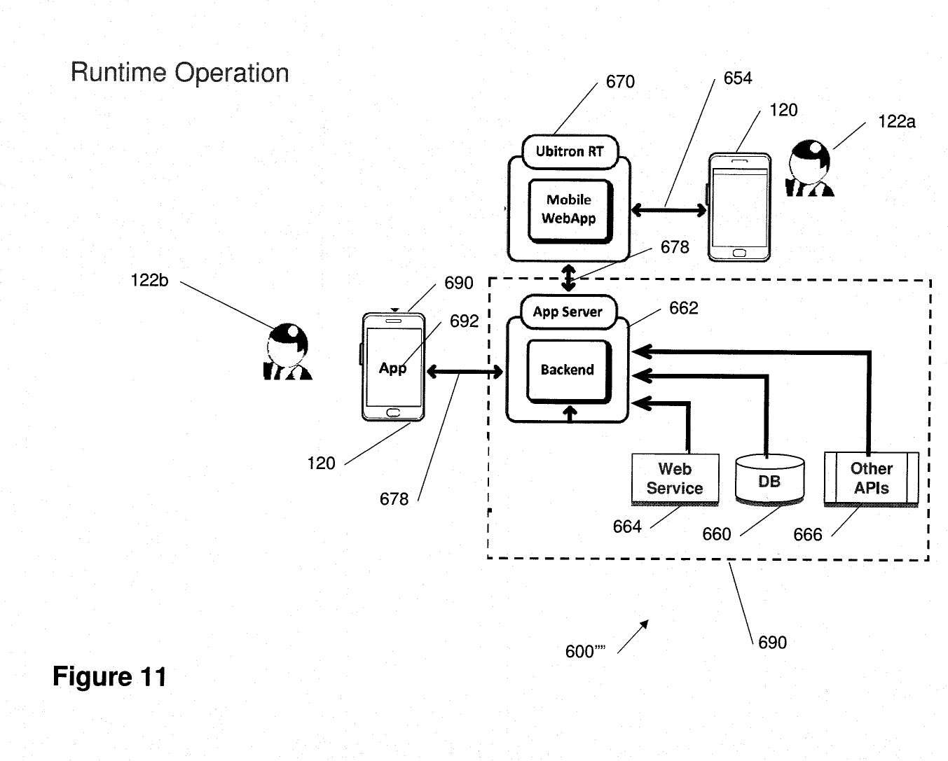

FIG. 11 schematically depicts the parts 600″″ of system 600 (seen in FIG. 6), used during the operation (runtime) of the system and its use by end user 122a browsing 654 the UI on his supported device 120, and by end user 122b executing application 692 to use the UI on his supported device 120.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

As used herein, the terms: “supported device”, “mobile device”, “mobile phone” or “Smart phone” and other terms related to the devices that may be used by the end user may include any mobile communication device and/or mobile computing device. Some embodiments of the invention are directed at creating codes that are adapted to e specific, and different requirements and specifications of such device. Some specific and different requirements and specifications of such device may be different for different types of supported devices, and may be different from requirements and specifications of common computing devices such as PC or laptop computer. These differences may be in one or more of: display size, user input means, operating system etc.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for creating a dynamic User Interface (UI) to be used on plurality of mobile devices of different types, the method comprising:
designing at least one Page template with a graphical Integrated Design Environment,
wherein designing said Page template comprises:
inserting at least one object in said at least one Page template;
designing the appearance of said Page template; and
defining behavior of said Page template according to predefined states;
using a graphical Integrated Design Environment for giving a name said at least one object in said at least one of the Page template; and
automatically generating a sample code,
wherein said sample code includes a code section comprising the name of said at least one object,
and sample data indicative of the said at least one object as appears in said Page template;
integrating a modified code by replacing in the sample code, the sample data with actual dynamic data capable of causing the sample code to send the corresponding data from a record in a dynamically updated database interactive with said mobile devices.

2. The method of claim 1, wherein:
said designing said Page template comprises further comprises associating said Page with at least one predefined state; and
said automatically generating a sample code further comprises automatically generating code capable of controlling the behavior of said Page depending on actual value of said state during browsing said Page.

3. The method of claim 1, and further comprising storing code capable of executing said method on a computer-readable media.

4. The method of claim 3, and further comprising executing said method on a computer.

5. The method of claim 4, and further comprising automatically generating Pages, configured to be browsed by a supported small-screen mobile device by executing said modified code.

6. The method of claim 5, wherein said supported small-screen mobile device is capable of browsing said Page via Internet.

7. The method of claim 4, and further comprising automatically generating application, configured to be executed on a supported small-screen mobile device by executing said modified code.

8. The method of claim 1, and further comprising dynamically updating said dynamically updated database.

9. The method of claim 8, wherein said dynamically updated database is a computer drive.

10. A system for creating a dynamic User Interface (UI) to be used on plurality of mobile devices of different types, the system comprising:
computer system, capable of enabling a UI designer to:
use a graphical Integrated Design Environment for designing at least one Page template,
wherein designing said Page template comprises:
inserting at least one object in said at least one Page template;
designing the appearance of said Page template; and
defining behavior of said Page template according to predefined states;
said computer system is further capable of enabling an integrator to:
use a graphical Integrated Design Environment for giving a name said at least one object in said at least one of the Page templates;
automatically generating a sample code,
wherein said sample code includes a code section comprising the name of said at least one object,
and sample data indicative of the said at least one object as appears in said Page template; and
integrating a modified code by replacing in the sample code, the sample data with actual dynamic data capable of causing the code to send the corresponding data from the relevant record in a dynamically updated database.

11. The system for of claim 10 and further comprising a plurality of supported devices;
a back-end server; and
at least one data source,
wherein said back-end server is capable of executing said modified code, and
capable of interacting with said plurality of supported devices, wherein said interaction of said back-end server with said plurality of supported devices comprises providing data from said data source to plurality of supported devices.

12. The system for of claim 11 wherein said plurality of supported device are selected from a group consisting of: Smartphones, Tablets; feature phones; Personal Digital Assistant (PDA), and personal media players with communication capabilities.

13. The system for of claim 11 wherein said interaction of said back-end server with said plurality of supported devices comprises communication over the Internet.

14. The system for of claim 13 wherein said interaction of said communication over the Internet comprising browsing web-pages generated by said back-end server on at least one of said plurality of said supported device.
